(19) United States
(12) Patent Application Publication
(10) Pub. No.: US 2010/0315424 A1
(43) Pub. Date: Dec. 16, 2010

(54) COMPUTER GRAPHIC GENERATION AND DISPLAY METHOD AND SYSTEM

(76) Inventor: Tao CAI, Palo Alto, CA (US)

Correspondence Address: Anova Law Group, PLLC, 8230 Boone Blvd, Suite 347, Vienna, VA, 22182, US

(21) Appl. No.: 12/814,506

(22) Filed: Jun. 14, 2010

Related U.S. Application Data
(60) Provisional application No. 61/186,907, filed on Jun. 15, 2009.

(51) Int. Cl. G06T 15/20

(52) U.S. Cl. 345/427

(57) ABSTRACT

A computer-implemented method is provided for generating and transforming graphics related to an object. The method includes obtaining one or more images taken from different points of view of the object, and a surface of the object is placed with a plurality of external markers such that control points for image processing are marked by the external markers. The method also includes building a spatial model from the one or more images based on the external markers, and processing the images to restore original color of parts of the one or more images covered by the external markers. Further, the method includes integrating texture from the restored images with the spatial model to build an integrated graphic model, and saving the integrated graphic model in a database.

### CROSS-REFERENCES TO RELATED APPLICATIONS

This application claims the priority of prior provisional patent application No. 61/186,907 filed on Jun. 15, 2009 to Tao Cai.

### FIELD OF THE INVENTION

The present invention generally relates to computer graphic technologies and, more particularly, to the methods and systems for generating and displaying computer graphics based on graphic models generated from one or multiple images.

### BACKGROUND

Computer graphics have been used in many areas such as computer-generated animated movies, video games, entertainments, psychology study, and other 2-dimensional (2D) and 3-dimensional (3D) applications. One task involved in generating and displaying computer graphics is to generate and/or to deform a graphic model containing both spatial and color information of an object of interest. There are many implementations of the graphic model, and one commonly-used computer graphic model is a textured surface, which is a combination of a 2D/3D spatial model and a texture. The 2D/3D spatial model may be in the form of a 2D/3D surface such as a polygon or spine surface. The texture is often in the form of a texture image of the object of interest.

However, conventional procedures to build and/or to deform such graphic model are often complex and may require special imaging devices. It might be impractical for ordinary people with ordinary cameras to use such procedures. For example, a 3D graphic model is generated either with a special scanner, like a laser scanner, a structure light scanner, or a calibrated multiple camera scanner, using image processing algorithms such as image based modeling and rendering or photogrammetry. The availability of these special scanners and the performance requirements of these algorithms may limit such conventional procedures only to a small number of people.

Image-based graphic model generation may use two categories of methods. The first category includes those methods directly using 3D points derived from multiple images of the object of interest. These 3D points can be in a sparse form (often called key points or feature points) or the dense form such like a depth map. A surface model can be directly generated from reconstructed sparse 3D points or the depth map by using surface fitting algorithms. The depth map can also be used for rendering graphics directly.

The second category includes morphing-based methods, in which a pre-defined template model is deformed into a user-specific model based on the multiple images. The template model or the user-specific model used in morphing can be a model with sparse control points or dense points.

Further, in image-based graphic model generation for the case of 2D graphic model, control points generated from one image or multiple images can be used directly to build the graphics model. The generation of the 3D model requires the reconstruction of 3D positions of points on the object of interest that are joint-viewed in multiple images. Basic procedures include: 1) detecting the feature points that are jointly visible in these multiple images and 2D positions of the feature points in each image; 2) finding the correspondence of points of a same feature point in each 2D image; and 3) combining the 2D positions, the correspondence of the 2D positions and geometric relationship of the images to reconstruct the 3D positions of the feature points, a 3D spatial model. For the depth map, each pixel is treated as a feature point and the 3D positions are calculated and form a depth image.

Once a 3D spatial model is built, texture can be generated from raw images used to build the 3D spatial model and mapped on the spatial model because a 2D-3D relationship between the raw image and the spatial model has been derived in the spatial model generation procedure. After the texture mapping, each pixel of the texture image is assigned one coordinate on the spatial model (called texture coordinate). However, two challenges exist. The first challenge is the recovering of the real color of the object from the raw images because the raw images may not capture the real color of the imaged object due to imaging factors such as lighting. The other challenge is the stitching of the images of different views into one complete texture image.

Another aspect of image model generation and deformation is to find the feature points and their 2D or 3D positions. One solution is putting easy-to-find markers on the object surface. For 3D model generation, multiple images of different views are taken in such a way that the markers used as feature points are visible at least in two images. Therefore, projections of a feature point in different images are physically generated from one same marker. However, conventional marker-based methods may require a large number of external markers, and the external markers cover the surface of the object and may corrupt images taken for the object (e.g., change of original color). The corrupted images used to construct the spatial model can no longer be used to build valid texture maps for the object. Thus, this disadvantage has limited applications of marker-based methods in the graphic model generation.

To overcome this defect, some marker-less methods have been developed to estimate the feature points and their positions through image processing technologies or through a user's manually labeling on marker-less images. Although these marker-less methods may maintain a complete texture, the position information of the feature points may be inaccurate because the feature points are the estimated results of algorithms or the user's judgment. Because their performance depends upon factors such as the algorithms, user's subjective judgment, the imaging condition and shape of the object, it is hard to achieve accuracy and robustness in the real world with these methods. Further, the manual labeling process is often very time-consuming, error-prone, and tedious.

The disclosed methods and systems are directed to solve one or more problems set forth above and other problems.

### BRIEF SUMMARY OF THE DISCLOSURE

One aspect of the present disclosure includes a computer-implemented method for generating and transforming graphics related to an object for a user. The method includes obtaining one or more images taken from different points of view of the object, and a surface of the object is placed with a plurality of external markers such that control points for image processing are marked by the external markers. The method also includes building a spatial model from the one or more images based on the external markers, and processing the one or more images to restore original color of parts of the one or more images covered by the external markers. Further, the method includes integrating texture from the restored images with the spatial model to build an integrated graphic model, and saving the integrated graphic model in a database.

Another aspect of the present disclosure includes a computer graphics and display system. The system includes a database, a processor, and a display controlled by the processor to display computer graphics processed by the processor. The processor is configured to obtain one or more images taken from different points of view of the object, a surface of the object being placed with a plurality of external markers such that control points for image processing are marked by the external markers. The processor is also configured to build a spatial model from the one or more images based on the external markers, and to process the one or more images to restore original color of parts of the one or more images covered by the external markers. Further, the processor is configured to integrate texture from the restored images with the spatial model to build an integrated graphic model, and to save the integrated graphic model in the database.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary graphic model generation process consistent with the disclosed embodiments;

FIG. 2 illustrates exemplary implementation of external markers consistent with the disclosed embodiments;

FIG. 3 illustrates an exemplary configuration for taking images consistent with the disclosed embodiments;

FIG. 4 illustrates one example of the multiple images from different viewpoints consistent with the disclosed embodiments;

FIG. 5 illustrates an exemplary marker placement, marker extraction and image restoration consistent with the disclosed embodiments;

FIG. 6 illustrates an exemplary work flow for generating a spatial model consistent with the disclosed embodiments;

FIG. 7 illustrates two images of a face and correspondence relationships of markers consistent with the disclosed embodiments;

FIG. 8 illustrates exemplary graphic models consistent with the disclosed embodiments;

FIG. 9 illustrates an exemplary graphic processing consistent with the disclosed embodiments;

FIG. 10 illustrates exemplary restored images and related color transformation consistent with the disclosed embodiments;

FIG. 11 illustrates exemplary results of a 3D graphic model consistent with the disclosed embodiments;

FIG. 12 illustrates an example of deformation of a user specific model consistent with the disclosed embodiments;

FIG. 13 illustrates an exemplary diagram of possible combinations of various models consistent with the disclosed embodiments;

FIG. 14 illustrates an exemplary template image and related color transformation consistent with the disclosed embodiments;

FIG. 15 illustrates an exemplary user specific model and a template model consistent with the disclosed embodiments;

FIG. 16 illustrates exemplary spatial models consistent with the disclosed embodiments;

FIG. 17 illustrates exemplary correspondence of control points of two spatial models consistent with the disclosed embodiments;

FIG. 18 illustrates exemplary hybrid models consistent with the disclosed embodiments;

FIG. 19 illustrates exemplary control points consistent with the disclosed embodiments;

FIG. 20 illustrates an exemplary correspondence derivation consistent with the disclosed embodiments; and

FIG. 21 illustrates an exemplary block diagram of computer graphic generation and display system.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

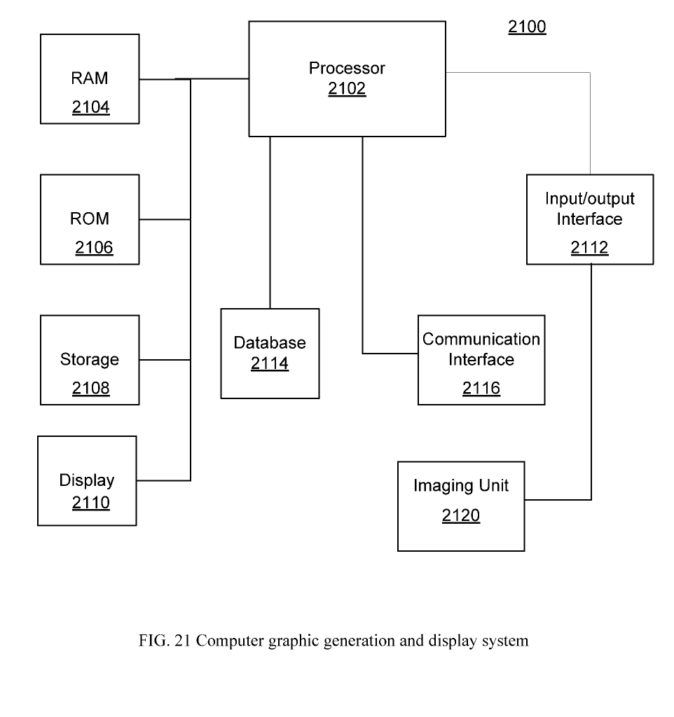

FIG. 21 shows an exemplary block diagram of computer graphic generation and display system 2100. As shown in FIG. 21, system 2100 may include a processor 2102, a random access memory (RAM) unit 2104, a read-only memory (ROM) unit 2106, a storage unit 2108, a display 2110, an input/output interface unit 2112, a database 2114; a communication interface 2116; and an imaging unit 2120. Other components may be added and certain devices may be removed without departing from the principles of the disclosed embodiments.

Processor 2102 may include any appropriate type of general purpose microprocessor, digital signal processor or microcontroller, and application specific integrated circuit (ASIC). Processor 2102 may execute sequences of computer program instructions to perform various processes associated with system 2100. The computer program instructions may be loaded into RAM 2104 for execution by processor 2102 from read-only memory 2106, or from storage 2108. Storage 2108 may include any appropriate type of mass storage provided to store any type of information that processor 2102 may need to perform the processes. For example, storage 2108 may include one or more hard disk devices, optical disk devices, flash disks, or other storage devices to provide storage space.

Display 2110 may provide information to a user or users of system 2100. Display 2110 may include any appropriate type of computer display device or electronic device display (e.g., CRT or LCD based devices). Input/output interface 2112 may be provided for users to input information into system 2100 or for the users to receive information from system 2100. For example, input/output interface 2112 may include any appropriate input device, such as a keyboard, a mouse, an electronic tablet, voice communication devices, or any other optical or wireless input devices. Further, input/output interface 2112 may receive and/or send data from and/or to imaging unit 2120.

Further, database 2114 may include any type of commercial or customized database, and may also include analysis tools for analyzing the information in the databases. Database 2114 may be used for storing image and graphic information and other related information. Communication interface 2116 may provide communication connections such that system 2100 may be accessed remotely and/or communicate with other systems through computer networks or other communication networks via various communication protocols, such as transmission control protocol/internet protocol (TCP/IP), hyper text transfer protocol (HTTP), etc.

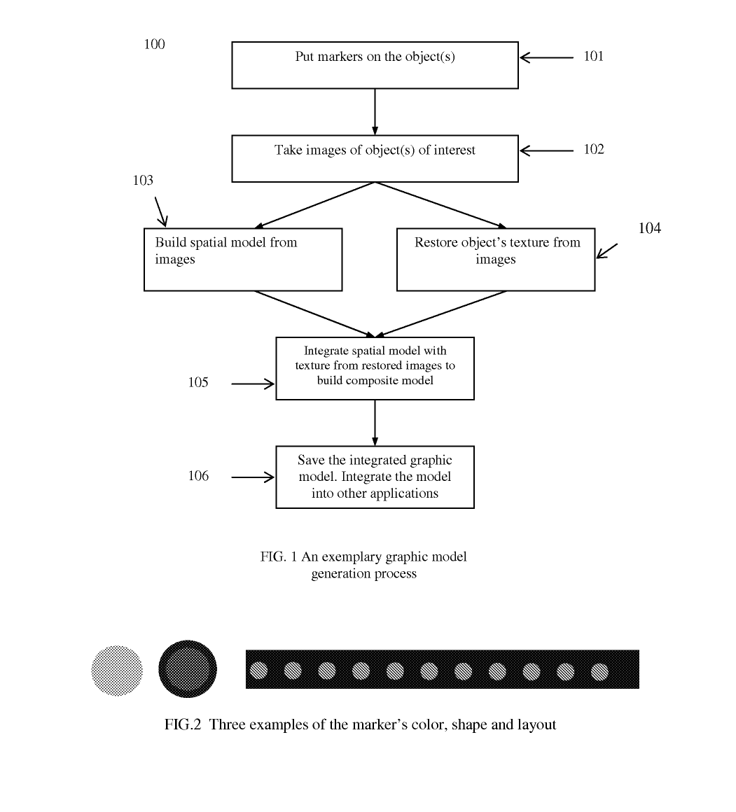

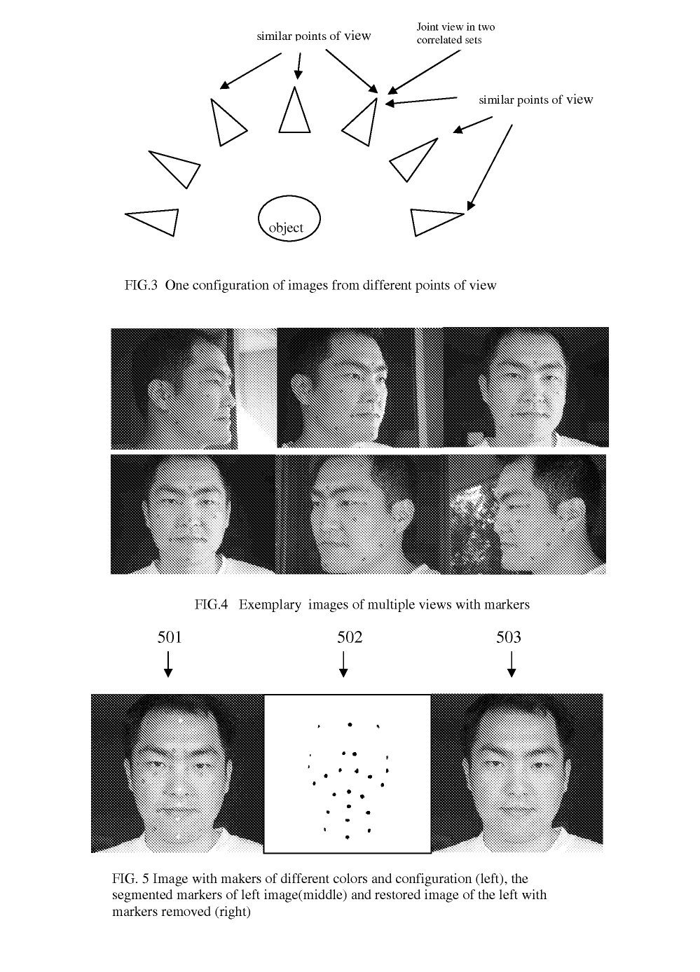

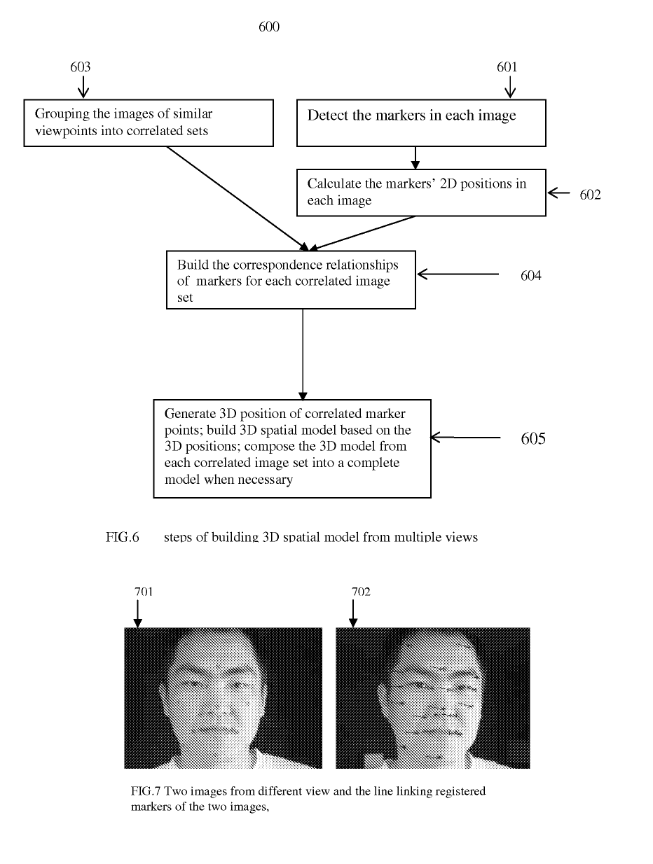

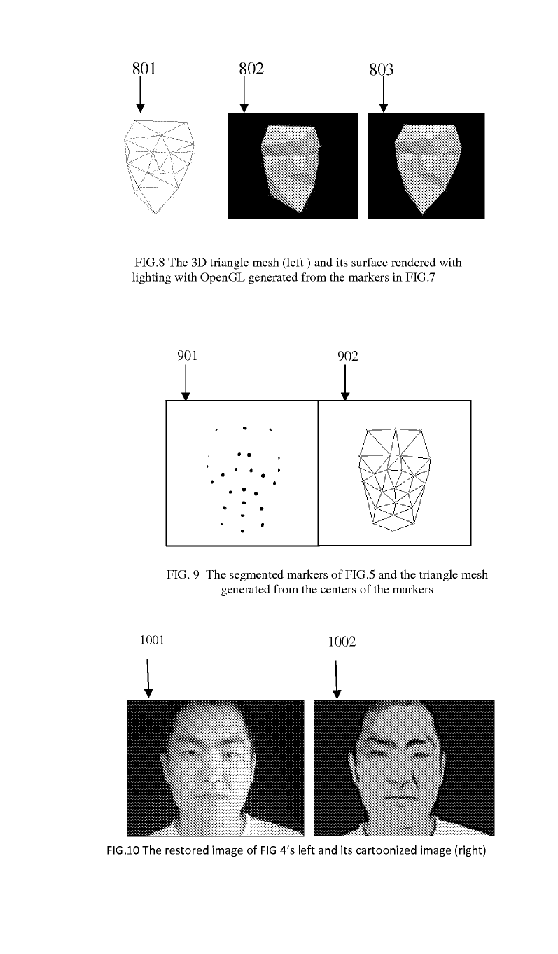

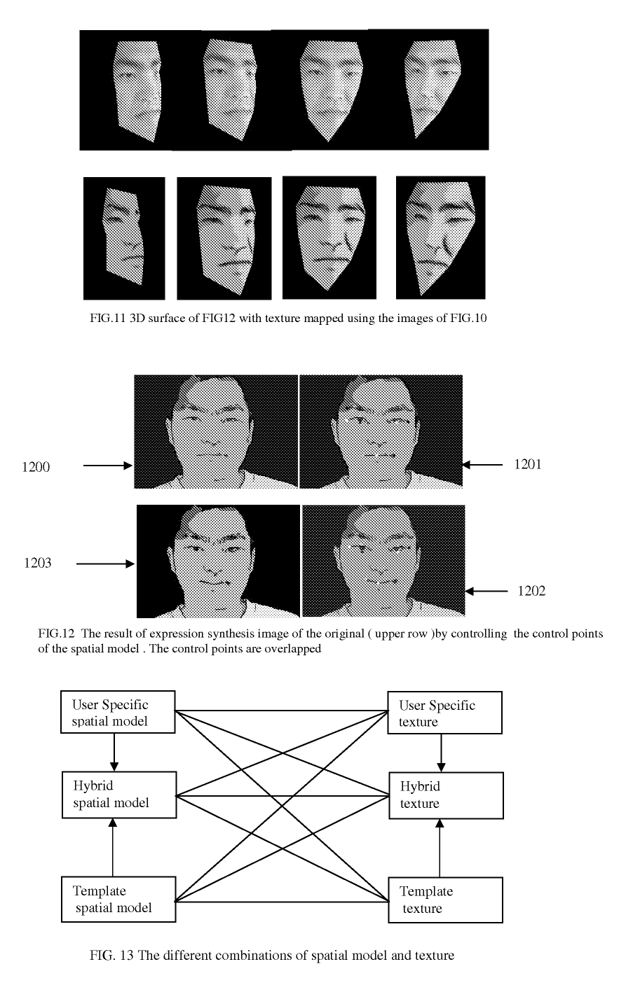

During operation, system 2100 or, more particularly, processor 2102 may perform certain processes to process images of an object of interest, to generate various graphic models, to deform the graphic models, and/or to render computer graphics. FIG. 1 shows an exemplary graphic model generation and deformation process using system 2100.

As used herein, the term “object” may include one entity or multiple entities of which a 2D/3D model is intended to be generated. Because a 2D model may be treated as a special case of a 3D model, the description herein is mainly in the context of 3D models and graphics. However, it is understood by people skilled in the art that the description also applies to 2D models and graphics. Further, although the description uses spatial models that are based on surfaces such as polygons or B-spline surfaces, other forms of graphic models, such as depth maps and volume data based models may also be used.

Further, certain terms are used herein according to their meanings as used in the technical fields of computer graphics and other related arts. For example, the term “texture,” as used herein, may be in the form a texture image containing color information of the object. For another example, the term “deformation” may include transformation of a spatial model and texture.

As shown in FIG. 1, at the beginning, a plurality of external markers are placed on an object's surface (101). The makers remain static relative to the object during the period when one or multiple images of the object are taken. The markers may be placed on explicit feature points on the object such that a total number of markers may be significantly small. Feature points, as used herein, may refer to those points on the object's surface that are representative of certain characteristics of the object, such as a point at a location of high curvature on the surface or boundary of a region, and 3D positions of feature points may be reconstructed from the multiple images.

The external markers may be created in certain ways. For example, an external marker may be directly painted on the surface of the object. The paint may be removable after taking images so that the markers will not cause any physical and cameral changes or damages to the object.

Further, external markers may be pre-made and adhered on the surface of the object. Pre-made external markers may include any appropriate type of commercial markers or labels, such as commodity labels like the “Avery Color-Coding Permanent Round Labels”. Further, pre-made external markers may also include customized markers or labels.

The markers may be made from any appropriate materials such that the markers' color does not change substantially in different positions, orientations, lighting and imaging conditions or materials that are able to generate diffuse reflection and/or retroreflection. For example, materials with rough surface may be used to minimize glare reflection, and materials being able to emit light may also be used.

Further, when external markers are adhered to the surface of the object, glue or the likes may be used. The glue used to adhere the external markers may be put on one side of the markers in advance as a whole package like the “Avery” adhesive stationery labels, or may be used separately. The compound of the glue may be selected or designed such that the glue does not cause any physical or chemical change or damage on the object. For instance, glue made from wheat or rice flour may be used on the face or surface of the object.

Markers may be designed according to certain criteria so as to simplify the latter processing such as marker detection, correlation and image restoration. For example, the color, shape, and/or placement of the markers are designed according to certain criteria. FIG. 2 shows exemplary illustrations of implementation of the markers.

As shown in FIG. 2, the color of a marker may be designed to be obviously different from the texture of the object such that the markers can be easily detected using image processing methods. Further, the shape of the marker may be designed to be a regular geometry shape like circular, square, and linear. The marker may be designed to be visible in images easily and not to cover a big portion of the object. The higher the resolution of the camera taking the images, the smaller the markers can be.

In certain embodiments, when the object is a human face or head, the color of the maker may be designed to be pure red, green or blue, and the size of the marker may be designed in a range of approximately 5×5 mm to 10×10 mm, depending on the resolution of the camera. One example of designing the external makers is cutting color paper with a rough surface or similar materials into pieces of regular shapes, such as circular pieces, and gluing them on the object. Another example is using the circular pieces with glue already on one side, similar to the adhesive stationery label, such that a user is not bothered to put glue on the markers.

Also, as shown in FIG. 2, linear markers may be used. For example, markers may be made into a strip shape. A strip-like marker can be in same color, as previously explained, or in different color at different label locations.

When the markers are put on the object (e.g., either by painting or by adhering), the number of markers and the position, color, and shape of the markers may be randomly chosen or may follow certain conventions or examples that are provided to a user in advance. These conventions and guidance are designed to provide additional constraints to simplify image processing procedures for model generation and deformation. Examples of the conventions may include: the markers are put at the points of the object surface with big curvature or are put at the same positions as the control points of a template model; and the markers of different color are put on different sides of the objects (e.g., left and right sides of a head of a human object), etc.

Further, guidance and examples about the shape, size, appearance, positions and number of the makers put on the object may be generated in advance and provided to the user in advance. For example, all images in the figures disclosed herein may be provided to the user as the examples. The examples may be different according to different applications, imaging devices, and conditions such as camera type, lens parameters and image resolution.

Returning to FIG. 1, after the plurality of external markers are placed on an object's surface (101), multiple images from different points of view of the object with markers are taken (102). These images may be taken with one camera (including video camera) at different times or with several cameras at the same time. FIG. 3 shows an exemplary configuration of the camera taking images from different viewpoints.

As shown in FIG. 3, images may be taken from different viewpoints and may be grouped in different sets. A set of images may include a series of images taken from similar points of view. Multiple sets of images may be used, and an image belonging to two different sets may be considered as taken from a joint view of two correlated sets. FIG. 4 shows one example of the multiple images from different viewpoints with markers on the points of big curvatures.

Further, as shown in FIG. 1, a spatial model may be built from the multiple images (103). To build the spatial model, the markers of the images need to be extracted in image processing procedures. Different ways to extract the markers may be used, and the examples described herein are for illustration purposes and not intended to be limiting.

During marker extraction, the position of a marker in an image may be calculated as the center of the markers' pixels. This processing may be simplified since the color of the marker may be intentionally selected to be different from the background (i.e., the color of the object). The detection and segmentation of markers for each image may be done by using: 1) automatic segmentation algorithms; 2) user's manual segmentation; or 3) a semi-automatic operation in which the user inspects and modifies/edits automatically processed results.

After the markers are extracted, the extracted markers may be used to build the spatial model, which will be described in detail in sections below. Because the markers on the object corrupt the original color of the object in the images, the original images with markers on the object may be unsuitable to be used directly. Therefore, the images are processed such that the original color of the parts covered by the markers is restored (104). In other words, the images or the texture of the images may be restored by removing the extracted markers by image processing techniques. Methods for this purpose are generally called “image restoration.” Any appropriate image restoration method may be used. More particularly, a specific category of image restoration methods called “image inpainting” may be used. For example, a mask-based inpainting method may be used because a segmented image used for the extraction of the makers may be used as an input mask for inpainting and the mask-based inpainting method generally produces good and robust results for image restoration.

FIG. 5 illustrates an exemplary marker extraction and image restoration. As shown in FIG. 5, image 501 shows an image including a face with markers of different colors. Image 502 shows the segmentation of the markers in image 501 using an automatic segmentation algorithm, such as a color cluster K-mean algorithm. Further, the region of the face can be segmented first, and the segmented face region may be used as known background to improve the accuracy and robustness of the segmentation of the markers. Further, image 503 shows a restored image of image 501, as the inpainting result of image 501 with image 502 as the mask.

As explained above, building spatial models may be performed based on the markers (103). For the purpose of illustration, 3D spatial models and reconstruction of 3D positions based on the markers are described. Other spatial models may also be used.

The reconstruction of the 3D positions of points from images of multiple views may be achieved using various methods. FIG. 6 shows an exemplary work flow for generating a spatial model. As shown in FIG. 6, at the beginning, system 2100 or processor 2102 detects the markers in each image (601). Processor 2102 also calculates the markers' 2D positions in each image (602). Further, processor 2102 groups the images of similar viewpoints into correlated sets (603). Processor 2102 further builds correspondence relationships of markers for each correlated image set (604). Processor 2102 then generates 3D positions of correlated marker points; and builds a 3D spatial model based on the 3D positions (605). When necessary, processor 2102 may compose the 3D model from integrating each correlated image set into a complete model.

The various methods of 3D position reconstruction may include a self-calibration based method that uses the images only. The correspondence relationships of the points (markers) may be obtained by user's interactive manual assignment or an automatic algorithm such as the RANSAC (RANdom SAmple Consensus) algorithm. FIG. 7 shows two images of a face and the correspondence relationships of the markers. Images 701 and 702 are two images from two viewpoints. The automatic correspondence algorithm used to build the corresponding relationships of points is the RANSAC algorithm. The lines with arrows in image 702 show the correlations of the correlated markers in images 701 and 702 generated with the RANSAC algorithm.

A spatial model with sparse control points may be directly generated using the markers as control points. For example, the Delaunay triangles from the sparse points and other more complicated surface models may be used. In FIG. 8, image 801 shows the Delaunay triangle generated from the reconstructed 3D points from images 701 and 702. Images 802 and 803 are the 3D views of the surfaces with lighting displayed with OpenGL. In FIG. 9, image 901 shows a set of the segmented markers, and image 902 shows an exemplary 2D Delaunay triangle using the segmented markers in image 901 as vertex points.

Returning to FIG. 1, after the spatial model is built (103) and the texture of the images is restored (104), the texture from the restored images is integrated with the spatial model to build a composite model (105). That is, to make a 2D/3D graphic model look more realistic, a texture image may be mapped on the spatial model. For example, texture coordinates for the control points of the spatial model are generated and the texture coordinates of all the pixels on the primitives of the spatial model are calculated by interpolating the texture coordinates of the control points.

In certain embodiments, inpainted images may be used to generate the texture images. Such images may be directly used as texture images or after some color transformation. In FIG. 10, image 1001 shows a restored image of one image in FIG. 4 (with the same inpainted algorithm) and its color transformed image 1002 that can be used as texture. The inpainted image 1001 has the same geometry as the original image. Hence, the coordinates of the makers in the corresponding original 2D image are the same as those in the inpainted image 1001 and can be used as the texture coordinates in the inpainted image 1001. This simplifies the texture coordinate generation of the control points of the spatial model since the 2D image coordinates of each markers are already known from the segmented image of the original image.

When multiple images are used to build an overall texture image, a stitching processing is used to combine several images. The stitching processing may be simplified by the known feature points' correspondence relationships. Since the texture coordinates of control points in each image are known, the texture coordinates in the overall texture image can be derived from the 2D image coordinates of the markers.

The spatial model, texture, and texture coordinates of the control points of the spatial model may form a complete graphic model used in computer graphics. FIG. 11 shows exemplary results of a 3D graphic model from different views with images in FIG. 10 as texture. The spatial model is the one shown in FIG. 8. The upper row shows results with the image 1001 as the texture. The images in the lower row are results using image 1002 as texture.

Other forms of graphic models, such as the depth map, may also be used and may be generated by using the markers as feature points to align the images of different views. The depth map may be used to generate spatial models with dense control points.

Returning to FIG. 1, after the integrated graphic model is generated (105), the integrated graphic model may be saved (106). Further, the integrated graphic model may be displayed to the user or may be further integrated into other applications, such as game programs and other programs. The model may be saved in database 2114. Models in database may be delivered into consumer electronics such as a cell phones and game consoles through networks. Further, system 2100 may be in a form of client-server system, in which imaging collection and display function runs in a client program and the processing function runs in a server program. The client program and server program communicates through any type of data connection such as the Internet.

In addition, the graphic model may be further processed by different other operations or algorithms, such as graphic deformation. The disclosed advantages in the generation of 3D feature points, texture image and texture coordinates, and the freedom of placing the external markers on any places of an object and using these markers as the control points may make the other operations simpler and more robust.

FIG. 12 shows an example of the deformation of a user specific model based on the marker-based control points. As shown in FIG. 12, a user specific 2D graphic model is used and image 1200 is used as texture. The control points of the user specific 2D model (a Delaunay triangle mesh) are shown in image 1201. Further, image deformation may be done by making certain changes about the control points. Image 1202 shows the control points of the deformed new model. In the deformed new model, the positions of the control points of the user specific model are changed to produce a different expression while the texture image and texture coordinates of the control points remain same. Images 1200 and 1203 show the visual difference of the two models, the original graphic model and the deformed graphic model.

For the purpose of illustration, a morphing-based model generation method for deformation is also described. The morphing-based model generation, which is generally done by moving the positions of the control points of a spatial template model guided by the user specific images, may be simplified with the disclosed methods and systems.

The morphing-based model generation usually requires the control points to be at the places on the object where the curvature is big enough such that the geometric features of the object are covered by the control points. This requirement can be fulfilled by placing the markers on the object in the same pattern as the control points of the spatial template model. Various morphing based algorithms may be used, such as AAM Active Appearance Models (AAMs) Fitting Algorithms.

As explained in sections below, external markers may be used for morphing a template model into a new user specific model. In addition, the application of external markers also makes building a new graphic model, i.e., a fused graphic model, by combination of a user specific model with a template graphic model much easier and robust. As to the morphing method (in which markers are placed on the user specific model in the same configuration as that of the template model), the corresponding relationship of the control points between user specific model and template model is known as a result. For the model generated with other methods, because the external markers can be placed on the object at the same positions or similar positions as control points of the template model displayed to a user in advance, the correspondence between the control points of the template model and the control points of the user specific model is intentionally set to a substantially one-to-one mapping, which is easy to be generated with manual labeling and/or automatic processing. Point matching algorithms may be used to automatically perform such processing, such as Iterative Closest Point (ICP) or other non rigid point matching algorithms.

Based on this correspondence of control points, the correspondence of the texture coordinates of the two sets of control points can also be obtained. This not only makes the combination of the user specific model and the spatial template model possible, but also makes it possible for combining the user specific spatial model with the template texture or vice versa. These combinations may produce hybrid models. A hybrid model, as used herein, may refer to a graphic model generated by integrating or combining two or more models. A hybrid spatial model or texture can also be combined with other models or textures. Therefore, more models with different visual effects may be produced.

FIG. 13 illustrates an exemplary diagram showing possible combinations of a user specific spatial model, a template spatial model, a hybrid spatial model, a user specific texture, a template texture, and a hybrid texture. Fully customized hybrid models may be generated by using different combinations.

The spatial template model and the texture used herein may be obtained independently so long as the texture coordinates of the control points are defined. The spatial template model may be obtained in many ways such as manual editing or using 3D scanners. One example of 2D face template spatial model is the MPEG-4 facial model.

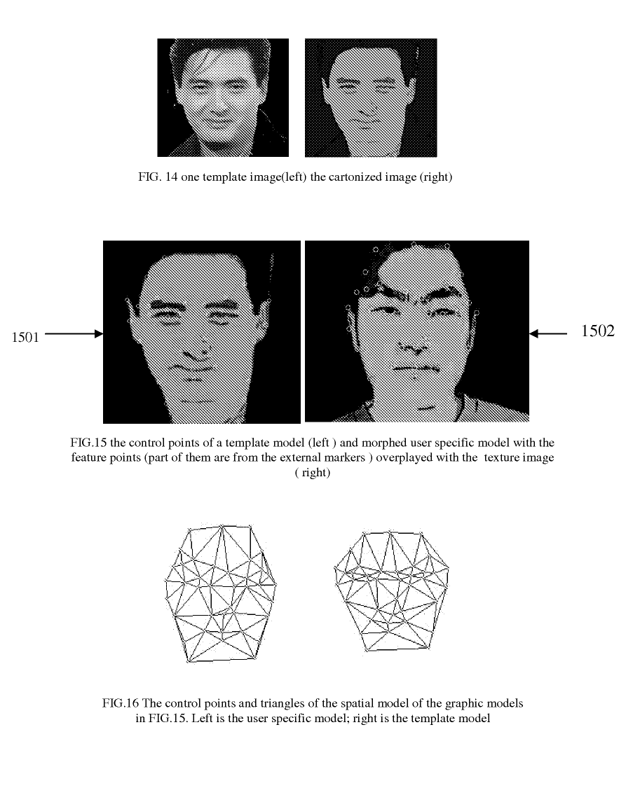

A template model may be based on the same object as the user-specific model, or the template may be based on a different object from the user-specific model. For example, for human face model generation, the user-specific model may be the face of a specific user, while the template can be the model of a cartoon character, a game character, or a different person or other non-human object. In FIG. 14, one image of a movie star and a corresponding processed image are shown. Both of the images may be used as template models or texture templates. A set of previously generated template models may be provided to a user in advance to guide placement of the markers and/or to be used later as template models to be morphed into user specific models and/or to generate hybrid models.

A hybrid model may be generated using various processes or steps. For example, a first step of hybrid spatial model generation may include finding correspondence of the markers and the control points of the template model.

As previously explained, the correspondence between the control points of the user specific model and the control points of the template model can be generated by user's manual editing and/or applying algorithms (semi-automatic or automatic). Because the markers may be put on the object at the same position as or similar position to the control points of the spatial template model in advance, the manual or automatic processing may be greatly simplified. Algorithms like ICP (Iterative Closest Point) or the non-rigid registration algorithms may be used.

FIG. 15 shows exemplary control points of two models. As shown in FIG. 15, template model 1501 shows a 2D template model using one image in FIG. 14 as a texture image. The control points of the spatial model (Delaunay triangle mesh) are overlapped on the texture image, and the control points of template model 1501 are also shown. Image 1502 shows the user specific model with the control points on the similar positions as the template model 1501, as the result of the morphing process. That is, image 1502 shows a user specific model morphed with the template model 1501 based on or guided by the control points.

Because this process is performed using the external markers, a user may have the control of the location, color, pattern of the markers. That is, the user may have the freedom to put the markers on the object same as or similar to the configuration of the control points of a template model displayed as an example in advance. The control points in the template model can also be differentiated with different colors, such as the markers in FIG. 5. Therefore, the user is guided to place the markers of the same or similar color on the same locations, adding new constraints to the morphing algorithms. Also, because knowledge of the color, configuration of the markers is known, this knowledge may be used to locate the location of the object before and within the morphing operation to improve operation quality.

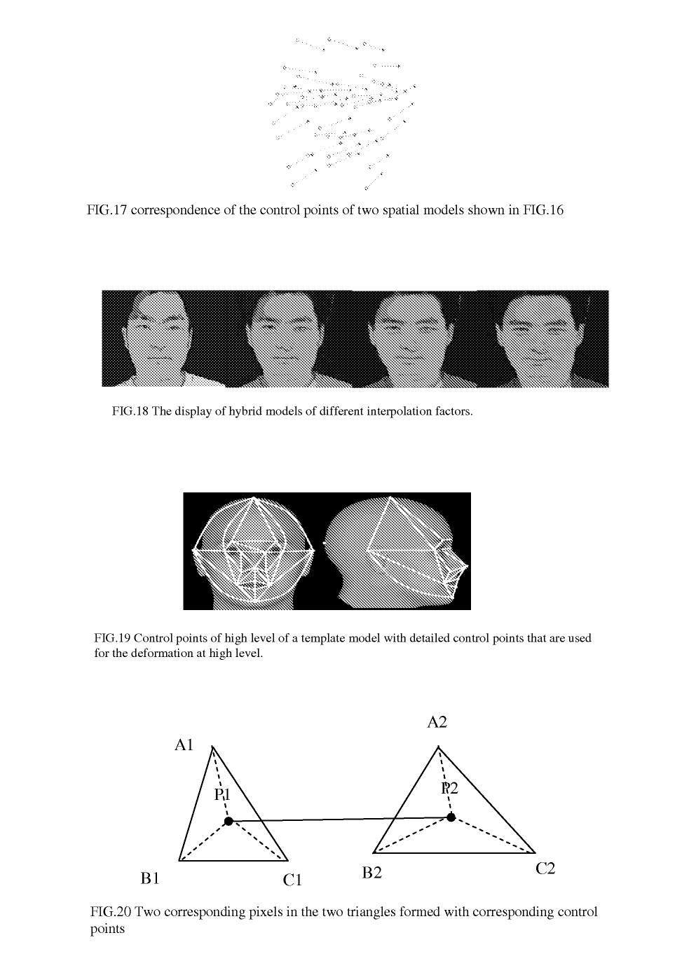

In FIG. 16, the control points and triangles of the spatial models in FIG. 15 are shown. The left image shows the user specific spatial model, and the right image shows the template spatial model. FIG. 17 shows the correspondence of the control points of the two spatial models in FIG. 16. The corresponding control points are linked with straight lines. The algorithm used for FIG. 17 is based on a non-rigid point registration algorithm.

A second step to generate the hybrid spatial model may include changing the positions of the control points of either of the user specific model or the template model. The new position of a control point can be a combination of the positions of correlated points of the two models. Certain algorithms may be used to determine the new position.

Provided that position vectors of the corresponding control points of two input spatial models are Uᵢ (user-specific) and Tᵢ (template), respectively, i=1 . . . N, and N is a total number of the control points. The position of the related control point of the hybrid model is Pᵢ=F(Uᵢ,Tᵢ,kᵢ), where F is a function, and kᵢ is a control variable for the extent of combination, which may be different or the same for all the control points.

Function F may be implemented in any appropriate function. In certain embodiments, function F may be implemented using a linear interpolation, as described below:
Let

$${C}_{u} = \frac{1}{N} {\sum }_{i} {U}_{i} and {C}_{t} = \frac{1}{N} {\sum }_{i} {T}_{i} ,$$

which are the center of the Uᵢ and Tᵢ, respectively, then relative positions of the control points to their centers.

U′ᵢ=Uᵢ−Cᵤ, and T′ᵢ=Tᵢ−Cₜ

The interpolated positions are: Pᵢ=U′ᵢ+kᵢ(T′ᵢ−U′ᵢ), in which kᵢ is the interpolation factor ranging from 0 to 1. The kᵢ can be different or the same for all the control points. In certain implementations, a user may be able to selectively set the kᵢ independently or jointly (all the control points use a same control factor) or partial-jointly (some control points use a same control factor).

The user may change certain parameters of the interpolation process through a graphic user interface (GUI). For example, when the user interactively changes a control factor, the control points which the control factor effects may be highlighted. Further, the value of the kᵢ may be interactively controlled by a slider bar or by moving a mouse or like mechanisms, such that the user can directly see the effect of the kᵢ on the generated model. That is, the markers/control points are used to guide the morphing of a predefined template model into a user-specific model.

Further, the control points of the template model may be divided into different levels of details. For example, the control points may be divided into one or more rough levels and one or more detailed levels. The control points of a rough level may be displayed to the user to guide the placement of the markers and/or may be used to build the correspondence with the marker-based control points.

The control points of a detailed level may be used as the control of the deformation of the template model, which may make the hybrid model more realistic and keep the user's operation at a minimum. The known correspondence of the control points at a rough level can be used as guidance or constraints for the change of positions of the control points at a detailed level to achieve more desired deformation. FIG. 19 shows an example of control points at a rough level of a 3D template model as well as control points at a detailed level.

Another method of using the control points at a detailed level in a template model is finding their corresponding feature points on the images of the object such as corner points detected with image processing algorithms, such that the detailed control points of the user specific model are generated.

A hybrid texture may be generated by combining the color of the corresponding pixels of different texture images (such as the user specific texture and template texture). During rasterization (a computer graphic process), the texture coordinates of a primitive's vertices (for example the triangle's vertices) are interpolated across the primitive such that each pixel making up the primitive has an interpolated texture coordinate. When a spatial model consisted of triangles is used, the Barycentric Coordinates of a point in one triangle may be used as its texture coordinates.

After the control points of the spatial model are assigned with texture coordinates, the texture image is divided into patches consisted of the geometric primitives of the spatial model (with control points as their vertex). Each pixel in the texture image is able to be assigned with texture coordinates by the interpolation of the texture coordinates of the control points of that patch where the pixel is located.

For two graphic models (e.g., a user-specific model and a template model), after the correspondence of the control points is built, when the control points in the two models are in a one-to-one mapping, the patches in the two textures of the two graphic models can be derived through the correspondence of the control points and are also in a one-to-one mapping. Therefore, one patch in one texture image has a corresponding patch in another texture. Thus, one point in one texture image can be associated with a corresponding point in another texture image. The corresponding point is in the corresponding patch and has the same interpolated texture coordinates as in the one patch.

FIG. 20 shows an exemplary correspondence derivation for the case of triangle based spatial models. The control point pairs A1-A2, B1-B2 and C1-C2 are corresponding control points of two spatial models, respectively. P1 and P2 are two points in the two triangles, respectively. The Barycentric Coordinates (the interpolated coordinates) of P1 in triangle A1-B1-C1 is (u,v,w). The Barycentric Coordinates of P2 in the triangle A2-B2-C2 is (r,s,t). The P1 and P2 are corresponding pixels when u=r, v=s and w=t.

In a digital image, the coordinates of a pixel is digitalized. If pixel P1 has image coordinates (i,j) of integer and value I1 (called intensity of pixel P1). Pixel P2 has image coordinates (x,y) of real number, and the intensity of P2 is defined as the interpolated intensity of position (x,y) within the texture image and has an integer value I2. An new hybrid texture image can be generated in which the intensity of a pixel at (i,j) is the combination of the I1 and I2, a linear interpolation.

FIG. 18 shows the hybrid models generated by the linear interpolation of both spatial model and texture. The leftmost image in FIG. 18 is a user specific model. The rightmost image is a template model (the cartoonized image in FIG. 14 by using an algorithm of Mean-shift filtering, a kind of color transformation algorithm). The other images in FIG. 18 are different hybrid graphic models generated with interpolated spatial model and texture images using different linear interpolation factors.

In addition, the user specific texture can be the restored image or an image derived from the restored image. The GUI for the interactive control of the generation of new texture may be similar to the GUI for interactive control of the spatial model.

Further, in a template model, each control point can be assigned with a semantic name, such as “left corner of the right eye”. Based on the correspondence between the control points in a user-specific model and the template model, each control point of the user-specific model can be assigned with the same name as its corresponding control point in the template model. This semantic labeling of the control points is very useful to guide the expression synthesis. One example is the MPEG-4 Facial Definition Parameters (FDPs) and Facial Animation Parameters (FAPs).

Results from the various disclosed graphic model generation methods and systems may be used by a variety of different applications and the implementation of the disclosed methods and systems may be through hardware (e.g., computer devices, handheld devices, and other electronic devices), software, or a combination of hardware and software, and software may include stand-alone programs, or client-server software that can be executed on different hardware platforms.

For example, the variety of different applications may include: 1) generating graphic models captured with an online camera or mobile equipment like a cell phone; 2) keeping the storage of the graphic models for users; 3) providing template models for the user to select from and to combine with the user's graphic models to build new graphic models (for instance, the hybrid models explained above), and the template models may be generated by other people or software/hardware and permitted to be used; 4) providing a data file of the generated graphic models in a format that can be imported into other software programs or instruments, such as MSN, and different games running on Xbox and Wii; 5) providing software and/or services to transfer the graphic models from the instruments where they are generated or stored to other software programs or instruments through data communication channels, such as internet and cell phone networks; and 6) providing the model generation, storage and transfer functions to the companies whose users may use the graphics models in their products. Other applications may also be included.

The disclosed methods and systems, and the equivalent thereof, are applicable to build graphic models with texture for human face, head, or body to be used in any 2D or 3D graphics applications, such as video games, animation graphics, etc. It is understood, however, that the disclosed systems and methods may have substantial utility in applications related to various 2D or 3D graphic model generation of non-human objects, such as creatures, animals, and other real 3D objects like sculptures, toys, souvenirs, presents and tools.

What is claimed is:

1. A computer-implemented method for generating and transforming graphics related to an object for a user, the method comprising:
obtaining one or more images taken from different points of view of the object, a surface of the object being placed with a plurality of external markers such that control points for image processing are marked by the external markers;
building a spatial model from the one or more images based on the external markers;
processing the one or more images to restore original color of parts of the one or more images covered by the external markers;
integrating texture from the restored images with the spatial model to build an integrated graphic model; and
saving the integrated graphic model in a database.

2. The method according to claim 1, wherein
the external markers have rough surfaces and are designed to be a regular geometry shape as one of circular, square, and linear; and to be in a color of one of pure red, green or blue.

3. The method according to claim 1, wherein building the spatial model further includes:
extracting the external markers in each of the one or more images;
calculating 2-dimensional (2D) positions of in the external markers in each of the one or more images;
grouping images of similar viewpoints into correlated image sets;
building correspondence relationships of the markers for each correlated image set;
generating 3-dimensional (3D) positions of the markers based on the correspondence relationships; and
building a 3D spatial model based on the 3D positions.

4. The method according to claim 1, wherein processing the image further includes:
applying a mask-based inpainting method using a segmented image resulted from extracting the makers as an input mask for inpainting.

5. The method according to claim 1, wherein integrating further includes:
mapping the texture from the restored images on the spatial model,
wherein texture coordinates for the control points of the spatial model are generated based on the texture from the restored images and the texture coordinates of all the pixels on the primitives of the spatial model are calculated by interpolating the texture coordinates of the control points.

6. The method according to claim 1, wherein integrating further includes:
mapping the texture from the restored images on the spatial model through a stitching processing based on correspondence relationships between known feature points of the restored images and the control points of the spatial model.

7. The method according to claim 1, further including:
deforming a user specific model into a new model based on modification of the control points generated from the external markers,
wherein positions of the control points of the user specific model are changed to produce a different expression while texture of the control points of the user specific model remain unchanged.

8. The method according to claim 1, further including:
morphing a template model into a user specific model guided by feature points extracted from the external markers.

9. The method according to claim 8, wherein
the control points in the template model are differentiated with different colors, and the different colors are used to guide the morphing and to add new constraints to a morphing algorithm.

10. The method according to claim 1, further including:
creating a user graphic model with a template graphic model to create a hybrid graphic model based on the external markers.

11. A computer graphics and display system, comprising:
a database;
a processor; and
a display controlled by the processor to display computer graphics processed by the processor,
wherein the processor is configured to:
obtain one or more images taken from different points of view of the object, a surface of the object being placed with a plurality of external markers such that control points for image processing are marked by the external markers;
build a spatial model from the one or more images based on the external markers;
process the one or more images to restore original color of parts of the one or more images covered by the external markers;
integrate texture from the restored images with the spatial model to build an integrated graphic model; and
save the integrated graphic model in the database.

12. The system according to claim 11, wherein
the external markers have rough surfaces and are designed to be a regular geometry shape as one of circular, square, and linear; and to be in a color of one of pure red, green, and blue.

13. The system according to claim 11, wherein, to build the spatial model, the processor is further configured to:
extract the external markers in each of the one or more images;
calculate 2-dimensional (2D) positions of in the external markers in each of the one or more images;
group images of similar viewpoints into correlated image sets;
build correspondence relationships of the markers for each correlated image set;
generate 3-dimensional (3D) positions of the markers based on the correspondence relationships; and
build a 3D spatial model based on the 3D positions.

14. The system according to claim 11, wherein, to process the image, the processor is further configured to:
apply a mask-based inpainting method using a segmented image resulted from extraction of the makers as an input mask for inpainting.

15. The system according to claim 11, wherein, to integrate, the processor is further configured to:
map the texture from the restored images on the spatial model,
wherein texture coordinates for the control points of the spatial model are generated based on the texture from the restored images and the texture coordinates of all the pixels on the primitives of the spatial model are calculated by interpolating the texture coordinates of the control points.

16. The system according to claim 11, wherein, to integrate, the processor is further configured to:
map the texture from the restored images on the spatial model through a stitching processing based on correspondence relationships between known feature points of the restored images and the control points of the spatial model.

17. The system according to claim 11, wherein the processor is further configured to:
deform a user specific model into a new model based on modification of the control points generated from the external markers,
wherein positions of the control points of the user specific model are changed to produce a different expression while texture of the control points of the user specific model remain unchanged.

18. The system according to claim 11, wherein the processor is further configured to:
morph a template model into a user specific model guided by feature points extracted from the external markers.

19. The system according to claim 18, wherein
the control points in the template model are differentiated with different colors, and the different colors are used to guide the morphing and to add new constraints to a morphing algorithm.

20. The system according to claim 11, wherein the processor is further configured to:
create a user graphic model with a template graphic model to create a hybrid graphic model based on the external markers.
